(19) United States
(12) Patent Application Publication
(10) Pub. No.: US 2024/0144157 A1
(43) Pub. Date: May 2, 2024

(54) INFORMATION PROCESSING METHOD

(71) Applicant: TOYOTA JIDOSHA KABUSHIKI KAISHA, Aichi-ken (JP)

(72) Inventors: Kazuyuki INOUE, Nagoya-shi (JP); Jean-Sebastien BOIRE, Yokohama-shi (JP); Kiyonori YOSHIDA, Toyota-shi (JP); Ai MIYATA, Hirakata-shi (JP); Yuki TATSUMOTO, Seto-shi (JP)

(21) Appl. No.: 18/498,038

(22) Filed: Oct. 31, 2023

(30) Foreign Application Priority Data
Nov. 2, 2022 (JP) 2022-176698

(51) Int. Cl. G06Q 10/083; B60L 58/30; G06Q 10/02; G06Q 30/0207

(52) U.S. Cl. CPC G06Q 10/083; B60L 58/30; G06Q 10/02; G06Q 30/0207

(57) ABSTRACT

An information processing method by an information processing apparatus capable of communicating with a vehicle that is a fuel cell electric vehicle, the information processing method includes acquiring a remaining hydrogen level and a delivery destination list for each vehicle that makes a delivery, identifying a location of a hydrogen filling station, and assigning, to the vehicle according to the remaining hydrogen level, a delivery destination close to the hydrogen filling station.

### CROSS-REFERENCE TO RELATED APPLICATION

This application claims priority to Japanese Patent Application No. 2022-176698, filed on Nov. 2, 2022, the entire contents of which are incorporated herein by reference.

### TECHNICAL FIELD

The present disclosure relates to an information processing method.

### BACKGROUND

Commercial fuel cell electric vehicles (FCEVs) are known (e.g., Patent Literature (PTL) 1). The FCEVs are filled with hydrogen at hydrogen filling stations.

### CITATION LIST

### Patent Literature

PTL 1: JP 2022-073238 A

### SUMMARY

The number of hydrogen filling stations is limited. Therefore, the efficient use of the hydrogen filling stations is required.

It would be helpful to assist the efficient use of hydrogen filling stations.

An information processing method according to an embodiment of the present disclosure is an information processing method by an information processing apparatus capable of communicating with a vehicle that is a fuel cell electric vehicle, the information processing method comprising:
acquiring a remaining hydrogen level and a delivery destination list for each vehicle that makes a delivery;
identifying a location of a hydrogen filling station; and
assigning, to the vehicle according to the remaining hydrogen level, a delivery destination close to the hydrogen filling station.

According to an embodiment of the present disclosure, the efficient use of hydrogen filling stations can be assisted.

### BRIEF DESCRIPTION OF THE DRAWINGS

In the accompanying drawings:

FIG. 1 is a schematic diagram of an information processing system according to the present embodiment;

FIG. 2 is a block diagram illustrating a configuration of an information processing apparatus;

FIG. 3 is a block diagram illustrating a configuration of a vehicle;

FIG. 4 is a flowchart illustrating operations of the information processing apparatus; and

FIG. 5 is a diagram illustrating a data structure of a vehicle database.

### DETAILED DESCRIPTION

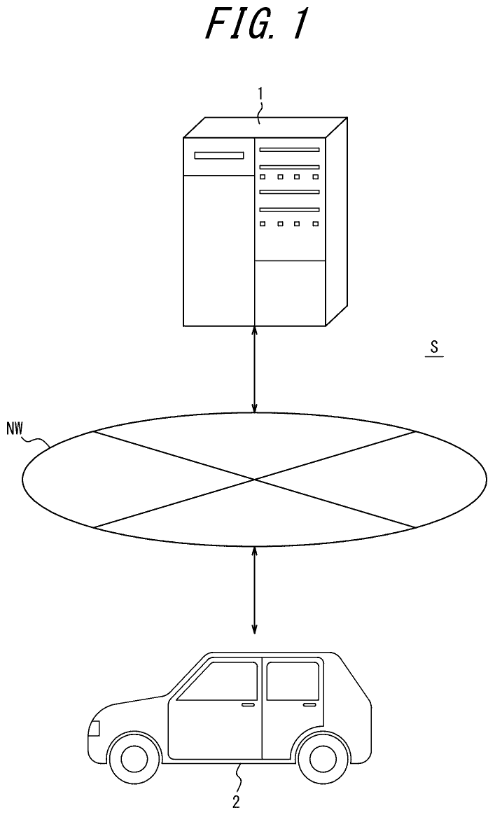

FIG. 1 is a schematic diagram of an information processing system S according to the present embodiment. The information processing system S includes an information processing apparatus 1 and a vehicle 2. The information processing apparatus 1 can communicate with the vehicle 2 via a network NW. The network NW includes, for example, a mobile communication network, the Internet, or a fixed communication network.

FIG. 1 illustrates one of the information processing apparatus 1 and one of the vehicle 2, for convenience of explanation. However, the number of information processing apparatuses 1 and the number of vehicles 2 are not limited to this. For example, processing to be executed by the information processing apparatus 1 may be executed by a plurality of distributed information processing apparatuses 1. The information processing apparatus 1 may be capable of communicating with multiple vehicles 2.

The information processing apparatus 1 may be a server configured to assist a provider in providing a service. The information processing apparatus 1 may be, for example, installed in a facility dedicated to the provider or in a shared facility including a data center. As an alternative example, the information processing apparatus 1 may be mounted in the vehicle 2. The information processing apparatus 1 may be referred to as a center server.

The vehicle 2 includes, for example, any type of automobile such as a gasoline vehicle, a diesel vehicle, an HEV, a PHEV, a BEV, or an FCEV. The term “HEV” is an abbreviation of hybrid electric vehicle. The term “PHEV” is an abbreviation of plug-in hybrid electric vehicle. The term “BEV” is an abbreviation of battery electric vehicle. The term “FCEV” is an abbreviation of fuel cell electric vehicle. The driving of the vehicle 2 may be automated at any level. The automation level is, for example, any one of Level 1 to Level 5 according to the level classification defined by SAE. The name “SAE” is an abbreviation of Society of Automotive Engineers. The vehicle 2 may be a MaaS-dedicated vehicle. The term “MaaS” is an abbreviation of Mobility as a Service. Alternatively, the vehicle 2 may be driven by a driver.

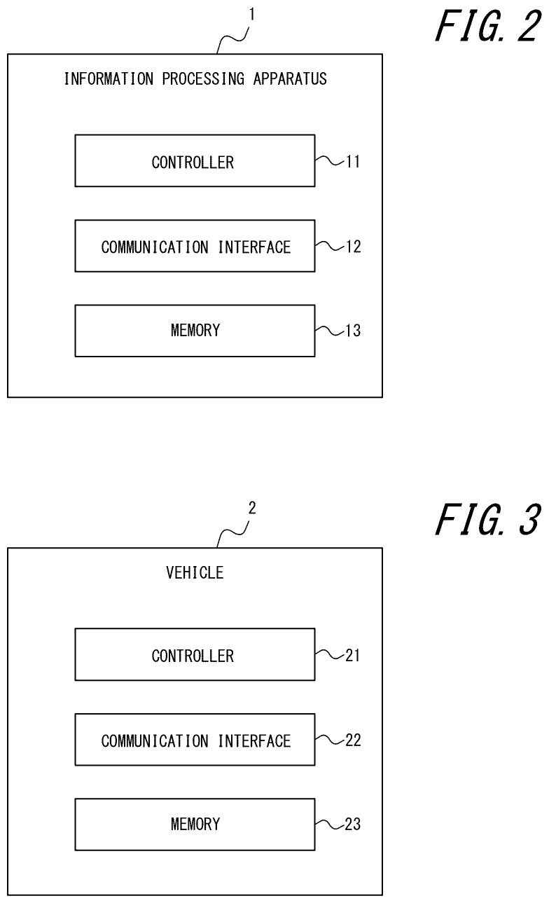

With reference to FIG. 2, an internal configuration of the information processing apparatus 1 will be described in detail.

The information processing apparatus 1 includes a controller 11, a communication interface 12, and a memory 13. The components of the information processing apparatus 1 are communicably connected to one another via, for example, dedicated lines.

The controller 11 includes, for example, one or more general purpose processors including a Central Processing Unit (CPU) or a Micro Processing Unit (MPU). The controller 11 may include one or more dedicated processors that are dedicated to specific processing. The controller 11 may include one or more dedicated circuits instead of the processors. Examples of the dedicated circuits may include a Field-Programmable Gate Array (FPGA) and an Application Specific Integrated Circuit (ASIC). The controller 11 may include an Electronic Control Unit (ECU). The controller 11 transmits and receives any information via the communication interface 12.

The communication interface 12 includes, for connecting to a network, one or more communication modules that conform to wired or wireless local area network (LAN) standards. The communication interface 12 may include a module conforming to one or more mobile communication standards including the Long Term Evolution (LTE) standard, the 4th Generation (4G) standard, or the 5th Generation (5G) standard. The communication interface 12 may include one or more communication modules conforming to near field communication standards or specifications, including Bluetooth® (Bluetooth is a registered trademark in Japan, other countries, or both), AirDrop® (AirDrop is a registered trademark in Japan, other countries, or both), IrDA, ZigBee® (ZigBee is a registered trademark in Japan, other countries, or both), Felica® (Felica is a registered trademark in Japan, other countries, or both), or RFID. The communication interface 12 transmits and receives any information via the network.

The memory 13 includes, for example, a semiconductor memory, a magnetic memory, an optical memory, or a combination of at least two of these, but is not limited to these. The semiconductor memory is, for example, RAM or ROM. The RAM is, for example, SRAM or DRAM. The ROM is, for example, EEPROM. The memory 13 may function as, for example, a main memory, an auxiliary memory, or a cache memory. The memory 13 may store information resulting from analysis or processing performed by the controller 11. The memory 13 may store various types of information or the like regarding operations or control of the information processing apparatus 1. The memory 13 may store a system program, an application program, embedded software, and the like. The memory 13 may be provided outside the information processing apparatus 1 and accessed by the information processing apparatus 1. The memory 13 includes a vehicle database.

With reference to FIG. 3, an internal configuration of the vehicle 2 will be described in detail.

The vehicle 2 includes a controller 21, a communication interface 22, and a memory 23. The components of the vehicle 2 are communicably connected to one another, for example, via dedicated lines.

Descriptions of the hardware configurations of the controller 21, the communication interface 22, and the memory 23 may be the same as the descriptions of the hardware configurations of the controller 11, the communication interface 12, and the memory 13, respectively. The explanation here is omitted.

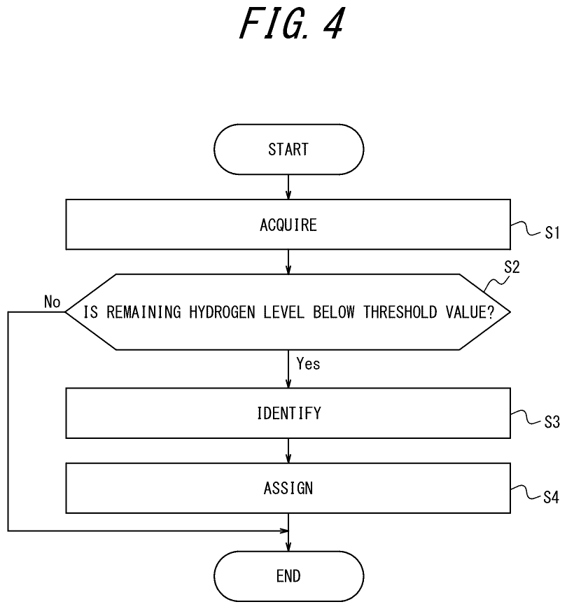

Hereinafter, in FIG. 4, an information processing method executed by the information processing system S according to the present embodiment will be described in detail. As an example here, the vehicle 2 delivers packages. The vehicle 2 is an FCEV. There may be more than one vehicle 2.

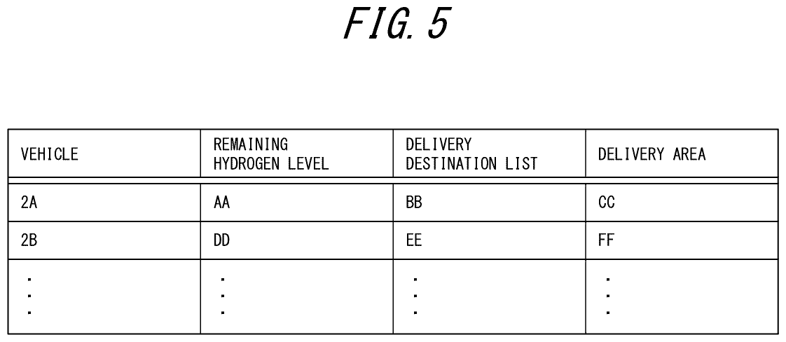

In step S1, the controller 11 of the information processing apparatus 1 acquires, from any other information processing apparatus, a remaining hydrogen level and a delivery destination list for each vehicle 2. As illustrated in FIG. 5, the controller 11 stores, in association with each vehicle, the remaining hydrogen level and the delivery destination list in the vehicle database of the memory 13. The delivery destination list includes, for example, information on each delivery destination and a time period to deliver a package to each delivery destination. As an additional example, the controller 11 may store a delivery area in association with each vehicle.

In step S2 of FIG. 4, the controller 11 determines whether the remaining hydrogen level of the vehicle 2 is below a threshold value. The threshold value can be set to any value.

When No in step S2, the controller 11 does not perform steps S3 and S4.

When Yes in step S2, the controller 11 identifies the location of a hydrogen filling station in step S3. There may be more than one hydrogen filling station. The location of the hydrogen filling station may be registered in advance in the memory 13. As an alternative example, the identification of the locations of one or more hydrogen filling stations may be performed prior to step S2.

In step S4, the controller 11 assigns, to the vehicle 2, a delivery destination close to the hydrogen filling station. For example, the controller 11 assigns, to the vehicle 2, a delivery destination whose distance or required time from the hydrogen filling station is below a threshold value. In this case, the controller 11 may accept a reservation for the hydrogen filling station from the vehicle 2. As an alternative example, the controller 11 may automatically book the hydrogen filling station. The controller 11 may suggest (recommend) to the vehicle 2 to make a reservation for the hydrogen filling station at a time period when there are no reservations from other vehicle. As an additional example, the controller 11 may offer a discount on a fee for the hydrogen filling station to the vehicle 2 that has made the reservation for the hydrogen filling station.

The controller 11 updates the delivery destination list in the vehicle database according to the assignment result. The vehicle 2 makes deliveries according to the updated delivery destination list. The vehicle 2 arrives at the hydrogen filling station at a reserved time period and is filled with hydrogen.

As an additional example, the controller 11 may read delivery area information from the vehicle database. The controller 11 determines, from the delivery area information, operating hours of the hydrogen filling station in the delivery area. The controller 11 accepts a reservation for the hydrogen filling station during the operating hours.

As an additional example, the controller 11 stores a reservation status of the hydrogen filling station in the memory 13. Upon accepting a request from any other terminal (e.g., delivery service provider terminal or general user terminal) to provide reservation status information on the hydrogen filling station, the controller 11 may provide the reservation status information.

According to the present embodiment, as described above, the controller 11 of the information processing apparatus 1 executes operations including acquiring the remaining hydrogen level and the delivery destination list for each vehicle, identifying the location of the hydrogen filling station, and assigning, to the vehicle 2 according to the remaining hydrogen level, the delivery destination close to the hydrogen filling station. This configuration allows the information processing apparatus 1 to create a delivery plan that takes into account the location of the hydrogen filling station, thus assisting the efficient use of a limited number of hydrogen filling stations. Furthermore, the information processing apparatus 1 can assist in the smooth hydrogen refueling of the vehicle 2.

According to the present embodiment, the operations of the controller 11 include, upon determining that the remaining hydrogen level is below the threshold value, assigning the delivery destination to the vehicle 2. This configuration allows the information processing apparatus 1 to assist in the smooth hydrogen refueling of the vehicle 2 that has insufficient hydrogen remaining.

According to the present embodiment, the operations of the controller 11 include accepting the reservation for the hydrogen filling station. This configuration allows the information processing apparatus 1 to assist in the hydrogen refueling of the vehicle 2 while improving convenience for the driver of the vehicle 2.

According to the present embodiment, the operations of the controller 11 include suggesting making the reservation for the hydrogen filling station at the time period when there is no reservation. This configuration allows the information processing apparatus 1 to assist a reliable reservation.

According to the present embodiment, the operations of the controller 11 include offering the discount on the fee for the hydrogen filling station to the vehicle 2 that has made the reservation. This configuration allows the information processing apparatus 1 to promote the reservation for the hydrogen filling station, thereby improving the utilization rate of the hydrogen filling station and thereby assisting efficient use.

While the present disclosure has been described with reference to the drawings and examples, it should be noted that various modifications and revisions may be implemented by those skilled in the art based on the present disclosure. Other modifications can be made without departing from the spirit of the present disclosure. For example, functions or the like included in each means or each step can be rearranged without logical inconsistency, and a plurality of means or steps can be combined into one or divided.

For example, in the aforementioned embodiment, a program configured to execute all or some of the functions or processing of the information processing apparatus 1 can be recorded on a computer readable recording medium. The computer readable recording medium includes a non-transitory computer readable medium and is, for example, a magnetic recording apparatus, an optical disc, a magneto-optical recording medium, or a semiconductor memory. The program is distributed, for example, by selling, transferring, or lending a portable recording medium such as a Digital Versatile Disc (DVD) or a Compact Disc Read Only Memory (CD-ROM) on which the program is recorded. The program may also be distributed by storing the program in a storage of any server and transmitting the program from any server to another computer. The program may be provided as a program product. The present disclosure can also be implemented as a program executable by a processor.

The computer temporarily stores in a main memory, for example, a program recorded on a portable recording medium, or a program transferred from the server. Then, the computer reads the program stored in the main memory using a processor, and executes processes in accordance with the read program using the processor. The computer may read a program directly from the portable recording medium, and execute processes in accordance with the program. The computer may, each time a program is transferred from the server to the computer, sequentially execute processes in accordance with the received program. Instead of transferring a program from the server to the computer, processes may be executed by a so-called ASP type service that realizes functions only by execution instructions and result acquisitions. The term “ASP” is an abbreviation of application service provider. Programs encompass information that is to be used for processing by an electronic computer and is thus equivalent to a program. For example, data that is not a direct command to a computer but has a property that regulates processing of the computer is “equivalent to a program” in this context.

1. An information processing method by an information processing apparatus capable of communicating with a vehicle that is a fuel cell electric vehicle, the information processing method comprising:
acquiring a remaining hydrogen level and a delivery destination list for each vehicle that makes a delivery;
identifying a location of a hydrogen filling station; and
assigning, to the vehicle according to the remaining hydrogen level, a delivery destination close to the hydrogen filling station.

2. The information processing method according to claim 1, comprising upon determining that the remaining hydrogen level is below a threshold value, assigning the delivery destination to the vehicle.

3. The information processing method according to claim 1, comprising accepting a reservation for the hydrogen filling station.

4. The information processing method according to claim 3, comprising suggesting making a reservation for the hydrogen filling station at a time period when there is no reservation.

5. The information processing method according to claim 3, comprising offering a discount on a fee for the hydrogen filling station to the vehicle that has made the reservation.
